(19) United States
(12) Patent Application Publication
(10) Pub. No.: US 2024/0362175 A1
(43) Pub. Date: Oct. 31, 2024

(54) SYSTEM ON CHIP AND INTERRUPT ISOLATION METHOD

(71) Applicant: Alibaba Innovation Private Limited, Singapore (SG)

(72) Inventors: Zhixing CHEN, Hangzhou (CN); Wenbin ZHENG, Hangzhou (CN)

(21) Appl. No.: 18/645,904

(22) Filed: Apr. 25, 2024

(30) Foreign Application Priority Data
Apr. 28, 2023 (CN) 202310486128.2

(51) Int. Cl. G06F 13/24

(52) U.S. Cl. CPC G06F 13/24

(57) ABSTRACT

A system on chip includes an interrupt controller, a processor, and an on-chip bus, wherein the interrupt controller is connected to the processor through the on-chip bus. The interrupt controller is configured to store execution environment identifiers corresponding to different execution environments; and send, after receiving a first interrupt instruction, the first interrupt instruction to the processor. The processor is configured to obtain, in response to the first interrupt instruction, a first execution environment identifier corresponding to the first interrupt instruction from the interrupt controller; and execute, when the first execution environment identifier is the same as a second execution environment identifier, the first interrupt instruction in a corresponding execution domain of a current execution environment, wherein the second execution environment identifier is an execution environment identifier of an execution environment to which a current execution domain belongs.

### CROSS-REFERENCE TO RELATED APPLICATIONS

The disclosure claims the benefits of priority to Chinese Application No. 202310486128.2, filed Apr. 28, 2023, which is incorporated herein by reference in its entirety.

### TECHNICAL FIELD

The present disclosure generally relates to computer technologies, and more particularly, to a system on chip and an interrupt isolation method.

### BACKGROUND

A Reduced Instruction Set Computing-Five (RISC-V)-based processor can implement, by configuring a Platform-Level Interrupt Controller (PLIC) and Trusted Firmware (TF), interrupt isolation of a Rich Execution Environment (REE) and a Trusted Execution Environment (TEE).

Generally, different execution environments correspond to different execution domains, and interrupt isolation needs to be performed between different execution domains. To implement isolation between different execution domains, the PLIC configures each external interrupt source to a Machine Mode (M-mode for short). After receiving an interrupt instruction from the interrupt source, a processor switches to the M-mode. The trusted firmware run in the M mode identifies an execution domain to which the interrupt source of the interrupt instruction belongs, and forwards the interrupt instruction to the execution domain. Then the processor switches to a Supervisor Mode (S-mode for short), and an operating system corresponding to the execution domain executes the interrupt instruction.

Processing of the foregoing interrupt instruction needs to be forwarded by using the trusted firmware, resulting in a slow response speed of the interrupt instruction and a large interrupt response delay.

### SUMMARY OF THE DISCLOSURE

Embodiments of the present disclosure provide a system on chip including an interrupt controller, a processor, and an on-chip bus, wherein the interrupt controller is connected to the processor through the on-chip bus. The interrupt controller is configured to store execution environment identifiers corresponding to different execution environments; and send, after receiving a first interrupt instruction, the first interrupt instruction to the processor. The processor is configured to obtain, in response to the first interrupt instruction, a first execution environment identifier corresponding to the first interrupt instruction from the interrupt controller; and execute, when the first execution environment identifier is the same as a second execution environment identifier, the first interrupt instruction in a corresponding execution domain of a current execution environment, wherein the second execution environment identifier is an execution environment identifier of an execution environment to which a current execution domain belongs.

Embodiments of the present disclosure provide an interrupt isolation method, applied on a processor. The method includes receiving a first interrupt instruction; obtaining a first execution environment identifier corresponding to the first interrupt instruction; and executing, when the first execution environment identifier is the same as a second execution environment identifier, the first interrupt instruction in a corresponding execution domain of a current execution environment, wherein the second execution environment identifier is an execution environment identifier of an execution environment to which a current execution domain belongs.

Embodiments of the present disclosure provide an interrupt isolation method, applied on an interrupt controller. The method includes storing execution environment identifiers corresponding to different execution environments; and sending, after receiving a first interrupt instruction, the first interrupt instruction to a processor.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is an architecture diagram of an exemplary processor based on a RISC-V architecture, according to some embodiments of the present disclosure.

FIG. 2 is a flowchart of transmission of an existing interrupt instruction.

FIG. 3 is another flowchart of transmission of an existing interrupt instruction.

FIG. 4 is a flowchart of exemplary transmission of an interrupt instruction, according to some embodiments of the present disclosure.

FIG. 5A is a flowchart illustrating exemplary transmission of an interrupt instruction, according to some embodiments of the present disclosure.

FIG. 5B is a flowchart illustrating another exemplary transmission of an interrupt instruction, according to some embodiments of the present disclosure.

FIG. 6 is a schematic diagram of a structure of an exemplary system on chip, according to some embodiments of the present disclosure.

FIG. 7 is a flowchart of an exemplary interrupt isolation method, according to some embodiments of the present disclosure.

FIG. 8 is a flowchart of another exemplary interrupt isolation method, according to some embodiments of the present disclosure.

FIG. 9 is a schematic diagram of a structure of an exemplary computer device, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

With rapid development of the Internet and the Internet of Things (IoT), a quantity of networking devices grows at a high speed, and an “Internet of Everything” becomes an important direction of future development of a network. Meanwhile, a variety of security problems are emerged. Currently, security risks such as cracking and data theft and tampering generally exist in an application, posing a significant threat to financial data security, personal privacy data protection, service data integrity, and the like. To resolve security threats faced by an intelligent device and an IoT device, a chip of an electronic device generally needs to provide a trusted execution environment, to ensure that system programs, device parameters, security data, and user data in the chip are not tampered with or illegally obtained. Currently, the trusted execution environment is widely applied to application fields such as mobility, payment, digital rights management (DRM), automobiles, unmanned aerial vehicles, the Internet of Things, and the like.

A conventional RISC-V processor does not provide a security isolation technology, and integrally runs in the rich execution environment. As a result, the trusted execution environment cannot be implemented. An execution environment refers to a running environment of an application service. For security, different application services need to be run in different execution environments. The execution environment generally includes a rich execution environment and a trusted execution environment. The rich execution environment is used for running a general operating system and an application program, for example, a Linux operating system or an Android operating system. The trusted execution environment is used for running an operating system and an application program that have special requirements for security, for example, a payment application program. To implement the trusted execution environment on a RISC-V architecture, in the present disclosure, based on physical memory protection (PMP) and a multi-layer privilege model provided in the RISC-V architecture, access space of the processor is divided into physical memory areas of any size, and different access permission is granted to different physical memory areas. In addition, a mutually isolated execution domain is virtualized for each physical memory area, and a domain identifier (Zone ID) is set for each execution domain, for example, Zone0, Zone1, or Zone2, so that each execution domain can independently run an operating system in a corresponding physical memory area and an application program based on the operating system. The processor runs in different execution domains in a time-sharing manner, and cooperates with another protection mechanism, for example, an system on chip (SoC), to jointly construct a security system based on software and hardware coordination, thereby implementing memory access isolation, peripheral isolation, input/output (I/O) isolation, execution isolation, interrupt isolation, and the like, meeting an isolation requirement of the trusted execution environment, and avoiding an unauthorized operation on software and hardware information in each execution domain by another execution domain.

A PMP mechanism is an attribute with a security extension capability provided in the RISC-V architecture, to isolate memory access in an M-mode and an S/U mode (User Mode). Generally, only the M mode has permission to configure the PMP. The PMP includes a plurality of groups of address registers and corresponding configuration registers (generally 8 to 16 groups), and the configuration registers may grant or reject permission to read (R), write (W), and execute (X) a physical memory area in the S/U mode. A register is a high-speed storage component with a limited storage capacity, to temporarily store instructions, data, and addresses. A register included in a control component of a processor includes an instruction register and a program counter; and a register included in an arithmetic and logic component of the processor includes an accumulator. In addition, the PMP may further protect memory mapping I/O (MMIO), and the trusted firmware in the M mode constrains the processor to access external I/O by configuring the PMP.

The PMP mechanism requires that each execution domain has one piece of PMP configuration information, and the PMP configuration information of each execution domain is written with access permission allowed by the corresponding physical memory area. When the processor switches from an execution domain to another execution domain, PMP configuration information is updated by the trusted firmware. Trusted firmware is a type of open source software, run in a security environment of hardware isolation and providing a security service. The hardware isolation refers to secure isolation implemented by a processor-based multi-core structure through an independent processor core. The security service includes an execution domain switching function, an interrupt interception function, and the like. The security service only exposes a limited interface, so that a probability of being attacked can be reduced. The trusted firmware has own resources and a unique execution thread, thereby further reducing the probability of being attacked. Specifically, the trusted firmware in the M mode first stores PMP configuration information of a current execution domain, and then loads PMP configuration information of a next to-be-switched-to execution domain, to complete switching of permission to access a memory and the memory mapping I/O (MMIO). When a plurality of execution domains need to share the memory, access permission of a physical memory area that needs to be jointly accessed may be granted to the plurality of execution domains at the same time, that is, allowed access permission of the physical memory area is written into the PMP configuration information of each execution domain.

The multi-layer privilege model is another attribute with a security extension capability provided in the RISC-V architecture, including but not limited to three working modes, for example, an M mode, an S mode, and a user mode (U mode for short). An administrator execution environment is run in the M mode, an operating system is run in the S mode, and an application program is run in the U mode. The M mode has highest permission, to manage execution of a plurality of S mode environments, and intercept an interrupt and abnormality from any S/U mode environment. An interrupt means that, in a running process of a computer, when host intervention is required for an unexpected situation, a machine can automatically stop a running program and switch to a program for processing a new situation, and return, after the processing is completed, to the stopped program to continue running. Generally, the M mode is a mandatory mode, the S/U mode is an optional mode, and different systems may be implemented by combining different modes.

In the M mode, access of the M mode may be limited in a limited physical memory area through a locking function of the PMP, for example, a physical memory area that allows only the access of the M mode and that is to be executed by the trusted firmware, so that impact on an M mode attack is reduced. The locking function of the PMP may be a supervisor memory access prevention (SMAP) mechanism and a supervisor memory execution prevention (SMEP) mechanism, and protection of key information is increased by using the locking function of the PMP.

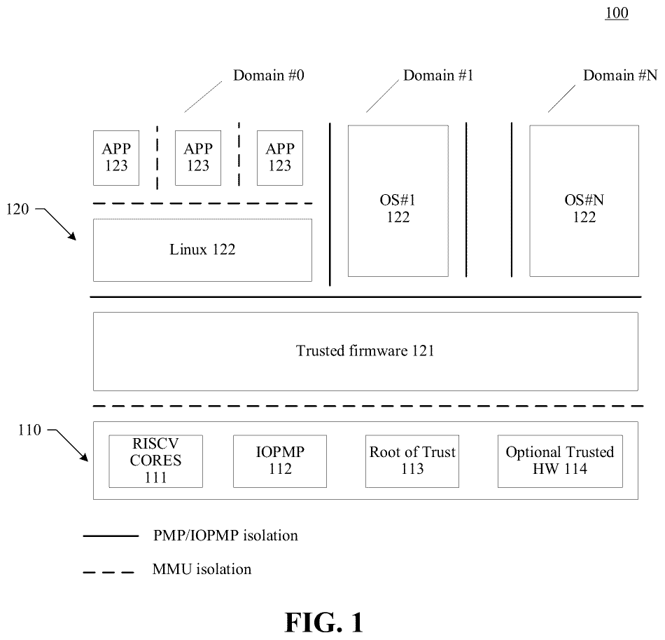

FIG. 1 shows an exemplary RISC-V architecture-based processor 100, according to some embodiments of the present disclosure. Referring to FIG. 1, the RISC-V architecture-based processor 100 includes a plurality of hardware resources 110, for example, RISC-V cores (RISC-V cores) 111, input/output physical memory protection (IOPMP) 112, root of trust 113, or an optional trusted firmware design (optional trusted hardware) 114. RISC-V architecture-based processor 100 further includes a multi-layer software 120 stack deployed on the hardware resources 110, for example, trusted firmware 121 run in an M mode, an operating system (OS) 122 run in an S mode, or an application program (APP) 123 run in a U mode. The foregoing RISC-V processor 100 can implement a rich execution environment and a trusted execution environment. Different execution environments correspond to different execution domains, and an execution domain corresponding to the rich execution environment is Domain #0, execution domains corresponding to the trusted execution environment are Domain #1 to Domain #N. Referring to FIG. 1, an operating system of the rich execution environment being a Linux is used as an example. Actually, the operating system of the rich execution environment may be alternatively another operating system, for example, an Android system. Through a memory management unit (MMU), the operating system of the rich execution environment is isolated from each application program running on the operating system, and various application programs are isolated. The operating system of the rich execution environment is isolated from an operating system of the trusted execution environment through a PMP mechanism or an IOPMP mechanism. Various operating systems of the trusted execution environment are isolated through the PMP mechanism or the IOPMP mechanism. The trusted firmware 121 is isolated from the operating system 122 through the PMP mechanism or the IOPMP mechanism. The trusted firmware 121 is isolated from a hardware device 110 through the MMU. By isolating software and hardware, the RISC-V processor 100 implements isolation of the trusted execution environment and the rich execution environment.

In the current existing design, a system on chip is provided. The system on chip includes the RISC-V architecture-based processor 100 shown in FIG. 1, a platform-level interrupt controller, and the like. The platform-level interrupt controller is configured to configure an interrupt priority of an external interrupt source, a privilege mode of the external interrupt source, an interrupt target, and the like. For security purposes, the platform-level interrupt controller sets all external interrupt sources to the M mode, and the platform-level interrupt controller is allowed to be accessed in only the M mode. In this way, after receiving an interrupt instruction of the external interrupt source, the RISC-V architecture-based processor needs to switch to the M mode, and then forwards the interrupt instruction by using the trusted firmware in the M mode.

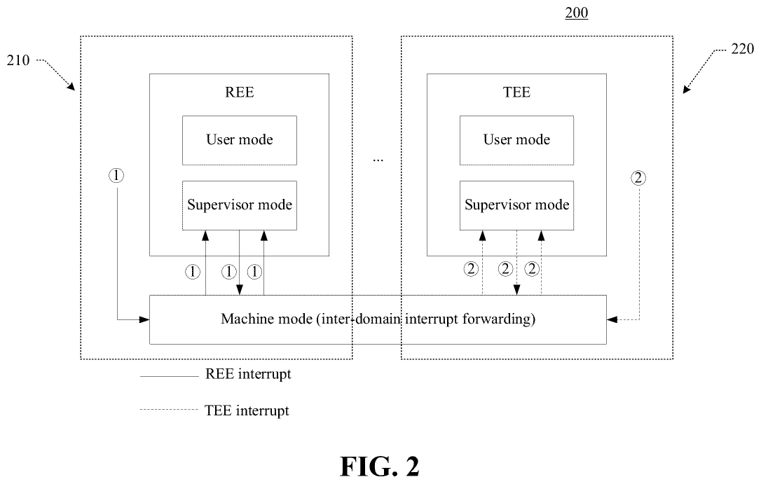

FIG. 2 is a flowchart 200 of transmission of an interrupt instruction based on an existing system on chip. Referring to FIG. 2, in a running process of the RISC-V architecture-based processor, for a processing process 210 of a REE interrupt instruction, when receiving a REE interrupt instruction sent by the platform-level interrupt controller (where the REE interrupt instruction refers to an interrupt instruction generated by an interrupt source on a REE side), the processor switches to the M mode. The trusted firmware run in the M mode stores context information of a current execution domain, and the processor determines an execution domain to which the REE interrupt instruction belongs. Then the processor sends the REE interrupt instruction to the execution domain, and switches from the M mode to the S mode, to execute the REE interrupt instruction by running the execution domain in the S mode. When the execution of the REE interrupt instruction is completed, the processor switches from the S mode to the M mode, and the trusted firmware obtains context information of an execution domain stored before the execution of the REE interrupt instruction, and then switches from the S mode to the M mode, to continue running the execution domain. A processing process 220 of a TEE interrupt instruction (where the TEE interrupt instruction refers to an interrupt instruction generated by an interrupt source on a TEE side) is also the same. Specifically, when receiving the TEE interrupt instruction sent by the platform-level interrupt controller, the processor switches to the M mode, where the trusted firmware run in the M mode stores context information of a current execution domain, and determines an execution domain to which the TEE interrupt instruction belongs; and then sends the TEE interrupt instruction to the execution domain, and switches the M mode to the S mode, to execute the TEE interrupt instruction by running the execution domain in the S mode. When the execution of the TEE interrupt instruction is completed, the processor switches from the S mode to the M mode, and the trusted firmware obtains context information of an execution domain stored before the execution of the TEE interrupt instruction, and then switches from the S mode to the M mode, to continue running the execution domain.

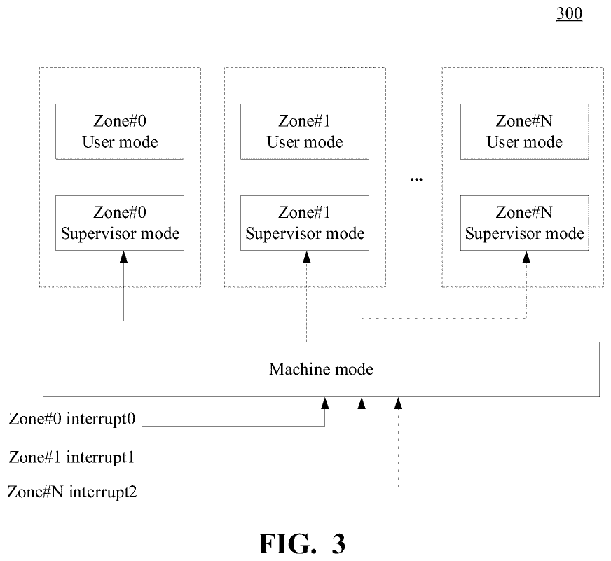

FIG. 3 illustrates another flowchart 300 of transmission of an interrupt instruction based on an existing system on chip. Referring to FIG. 3, interrupt instructions: interrupt0, interrupt1, and interrupt2 belong to Zone #0, Zone #1, and Zone #2 respectively. When receiving the interrupt0, the RISC-V architecture-based processor switches to the M mode, and then sends the interrupt0 to the Zone #0 for execution. When receiving the interrupt1, the RISC-V architecture-based processor switches to the M mode, and then sends the interrupt1 to the Zone #1 for execution When receiving the interrupt2, the RISC-V architecture-based processor switches to the M mode, and then send the interrupt2 to the Zone #2 for execution.

It can be seen from FIG. 2 and FIG. 3 that, in an existing interrupt instruction processing method, whether it is the REE interrupt instruction or the TEE interrupt instruction, all interrupt instructions need to be forwarded by using the trusted firmware, which increases complexity of a trusted firmware design, and also causes an interrupt response delay. In addition, for security purposes, the platform-level interrupt controller is allowed to be accessed in only the M mode, and each execution domain is run in the S mode. In this way, access of an interrupt service program to the platform-level interrupt controller needs to be switched to the M mode, further increasing the complexity of the trusted firmware design and the interrupt response delay.

To improve a speed of an interrupt response, shorten the interrupt response delay, and reduce the complexity of the trusted firmware design, in embodiments of the present disclosure, an original system on chip is improved, and the improvement is embodied in two aspects of software and hardware.

In terms of the software, based on an execution environment to which an interrupt source belongs, the interrupt source is classified. For example, the interrupt source is classified into an interrupt source of a REE or an interrupt source of a TEE, and different working modes are set for interrupt sources of different types. Considering that most of interrupts received by the processor are interrupts on a REE side, to ensure interrupt performance of the REE side and reduce the complexity of trusted firmware design, in some embodiments of the present disclosure, the interrupt source of the REE is set to an S mode, and the interrupt source of the TEE is set to an M mode. In some embodiments, to improve performance of a TEE side, the complexity of the trusted firmware design may be properly increased, and the interrupt source of the TEE is further set to the S mode.

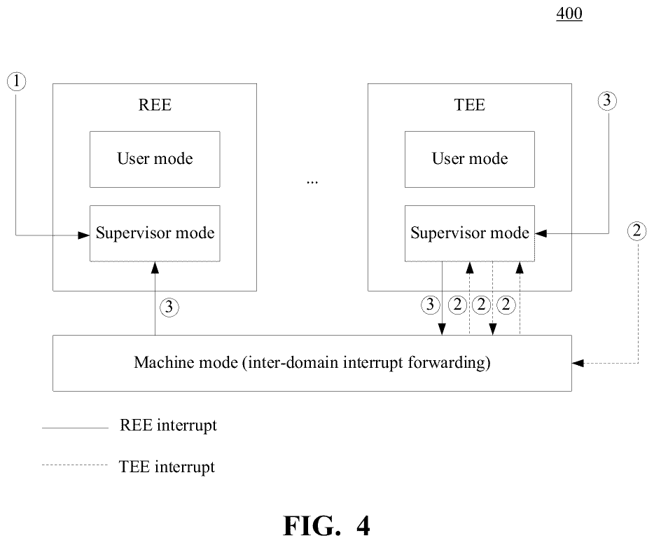

Based on innovation of the software, FIG. 4 is a flowchart of transmission 400 of an interrupt instruction, according to some embodiments of the present disclosure. Referring to FIG. 4, a platform-level interrupt controller sets an interrupt source of a REE to an S mode, and an interrupt of a TEE to an M mode. When receiving a REE interrupt instruction \textcircled{1} sent by the platform-level interrupt controller, a RISC-V architecture-based processor does not need to switch to the M mode when an execution domain of the REE interrupt instruction is the same as a current execution domain, and may directly execute the REE interrupt instruction \textcircled{1}. When receiving a TEE interrupt instruction \textcircled{3} sent by the platform-level interrupt controller, the RISC-V architecture-based processor switches to the M mode, and forwards the TEE interrupt instruction \textcircled{3} by using trusted firmware in the M mode. A processing flow of the TEE is the same as a processing flow 220 of the TEE shown in FIG. 2. Through comparison, it can be seen that, in some embodiments of the present disclosure, there is no need to forward by using the trusted firmware when the execution domain of the REE interrupt instruction is the same as the current execution domain, thereby improving the interrupt performance of the REE side.

In terms of the hardware, when the trusted firmware is initialized, different execution environment identifiers may be set for different execution environments, and an interrupt controller stores the execution environment identifiers corresponding to the different execution environments. By storing the execution environment identifiers corresponding to the different execution environments, isolation of a plurality of execution environments such as the REE and the TEE, can be achieved, and compared with isolation of the REE and the TEE that can be implemented in the prior art, a processing capacity of the RISC-V architecture-based processor is improved on a premise that operational security is ensured. When an execution environment to which an interrupt source belongs is the same as a current execution environment, there is no need to switch to the M mode. The RISC-V architecture-based processor can directly access the interrupt controller, thereby improving the speed of the interrupt response, shortening the interrupt response delay, and improving the interrupt performance of the REE side and improving interrupt performance of the TEE side.

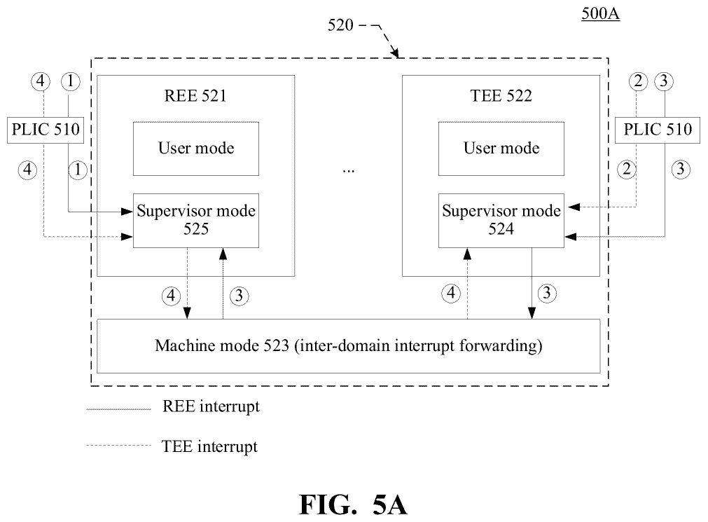

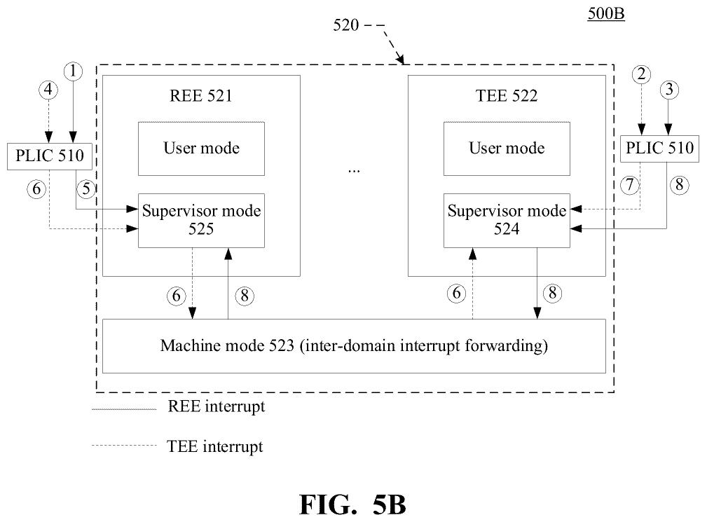

Based on innovation of the hardware, FIG. 5A and FIG. 5B are flowcharts illustrating exemplary transmission of an interrupt instruction, according to some embodiments of the present disclosure. Referring to FIG. 5A, when a current execution environment is a REE, a RISC-V architecture-based processor 520 receives a REE interrupt instruction \textcircled{1} sent by a platform-level interrupt controller (PLIC) 510, determines that an execution environment corresponding to the interrupt instruction is the same as the current execution environment, and directly executes the interrupt instruction in an execution domain related to the execution environment. When the current execution environment is a TEE, the RISC-V architecture-based processor 520 receives a TEE interrupt instruction \textcircled{3} sent by the platform-level interrupt controller 560, determines that an execution environment corresponding to the interrupt instruction is the same as the current execution environment, and directly executes the interrupt instruction in an execution domain related to the execution environment. By using the method provided in some embodiments of the present disclosure, for an interrupt at a REE side or an interrupt at a TEE side, when the current execution environment is the same as an execution environment to which an interrupt source belongs, there is no need to forward by using the trusted firmware, thereby improving interrupt performance of each execution environment, and shortening an interrupt response delay.

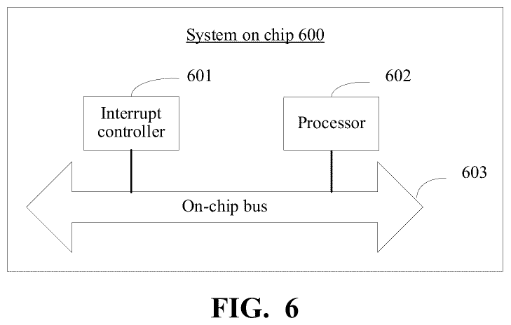

FIG. 6 illustrates an exemplary system on chip 600, according to some embodiments of the present disclosure. Referring to FIG. 6, system on chip 600 includes an interrupt controller 601, a processor 602, and an on-chip bus 603. The processor 602 is a RISC-V architecture-based processor. The interrupt controller 601 is connected to the processor 602 through the on-chip bus 603.

The interrupt controller 601 may be a platform-level interrupt controller or the like. The interrupt controller 601 is improved on a basis of an original interrupt controller. The interrupt controller 601 may not only configure, as an existing interrupt controller does, an interrupt priority of an external interrupt source, a privilege mode of the external interrupt source, an interrupt target, and the like, but also store execution environment identifiers corresponding to different execution environments. The different execution environment identifiers are set by trusted firmware during initialization. By storing the execution environment identifiers corresponding to the different execution environments, which is equivalent to dividing interrupts of the interrupt controller 601 for execution environments, each execution environment may have an own independent interrupt, and there is no longer need to forward by using the trusted firmware.

In some embodiments of the present disclosure, the different execution environments include at least a TEE and a REE, and further include another execution environment, for example, a CEE or a DEE. A quantity of execution environment identifiers stored in the interrupt controller may be determined based on a memory of the interrupt controller. If the memory of the interrupt controller is 4 bit, the interrupt controller may support storing execution environment identifiers of 16 execution environments.

To improve a speed of an interrupt response and shorten an interrupt response delay, the interrupt controller further sets different working modes for interrupt sources corresponding to the different execution environments. Specifically, an interrupt source corresponding to the REE may be set to an S mode, and an interrupt source corresponding to the TEE is set to the S mode. To reduce complexity of a software design, the interrupt source corresponding to the TEE may be alternatively set to an M mode. By setting the different working modes for the interrupt sources corresponding to the different execution environments, interrupt performance of a REE side can be ensured from a software level, and interrupt performance of a TEE side can also be improved to a maximum extent.

A register of the processor 602 stores an execution domain identifier of a current execution domain. When an execution domain of the processor 602 is switched, an execution domain identifier stored in the register is also updated along with switching of the execution domain. The register of the processor 602 further stores a correspondence between an execution domain identifier and an execution environment identifier, so that a second execution environment identifier of a current execution environment can be determined based on the execution domain identifier of the current execution domain.

In some embodiments of the present disclosure, the interrupt controller 601 may receive an interrupt instruction generated by an external interrupt source, and then forward the received interrupt instruction to the processor 602. The processor 102 executes the interrupt instruction. When the interrupt controller 601 forwards the interrupt instruction, the interrupt instruction may be directly forwarded; or the interrupt instruction may be processed, to generate a new interrupt instruction carrying an execution environment identifier of an execution environment to which an interrupt source belongs. The two cases are separately described as below.

In a first case, the interrupt controller directly forwards the interrupt instruction.

When a target interrupt source generates a first interrupt instruction, the target interrupt source sends the first interrupt instruction to the interrupt controller 601. After receiving the first interrupt instruction, the interrupt controller 601 sends the first interrupt instruction to the processor 602. In response to the first interrupt instruction, the processor 602 obtains a first execution environment identifier corresponding to the first interrupt instruction from the interrupt controller 601, and obtains a second execution environment identifier of an execution environment to which a current execution domain belongs, to compare the first execution environment identifier with the second execution environment identifier. When the first execution environment identifier is the same as the second execution environment identifier, in other words, the execution environment to which the current execution domain belongs is the same as an execution environment to which an interrupt source sending the first interrupt instruction belongs, the processor 602 executes the first interrupt instruction in a corresponding execution domain of the current execution environment.

The first interrupt instruction carries a target interrupt source identifier. To better manage interrupts of different interrupt sources, a register of the interrupt controller 601 stores a correspondence between an interrupt source identifier and an execution environment identifier. A process in which the processor 602 obtains the first execution environment identifier corresponding to the first interrupt instruction from the interrupt controller 601 is as follows: After receiving the first interrupt instruction, the processor 602 may send an access request to the interrupt controller 601, and the access request carries the target interrupt source identifier. In response to the access request, the interrupt controller 601 obtains the first execution environment identifier corresponding to the target interrupt source identifier based on the stored correspondence between the interrupt source identifier and the execution environment identifier, and then sends the first execution environment identifier to the processor 602.

To improve security of data stored in the interrupt controller 601, in existing design, the processor needs to be in the machine mode to access the interrupt controller 601. However, the processor 602 in embodiments of the present disclosure may directly access the interrupt controller 601, so that the interrupt response is accelerated, and the complexity of the software design is reduced.

Further, to avoid abnormality caused by unauthorized access of the processor 602 to the interrupt controller 601, the processor 602 may carry the second execution environment identifier in the access request. When receiving the access request sent by the processor, the interrupt controller 601 parses the access request to obtain the second execution environment identifier, and then determines whether the second execution environment identifier is a stored execution environment identifier. When the second execution environment identifier is a stored execution environment identifier, in other words, the processor 602 has permission to access the interrupt controller, the processor 602 is allowed to access, to execute the operation of obtaining the first execution environment identifier corresponding to the target interrupt source identifier. When the second execution environment identifier is not a stored execution environment identifier, in other words, the processor 602 does not have permission to access the interrupt controller 601, the processor 602 is rejected to access, thereby avoiding unauthorized access of the processor without permission to access the interrupt controller.

In some embodiments, when the processor 602 accesses the interrupt controller 601, verification is performed on access of the processor based on an execution environment identifier of the current execution environment, so that the access of the processor to the interrupt controller is limited in each execution environment, and security of the system on chip is improved.

In some embodiments, when corresponding execution domains are divided into for the different execution environments based on a physical memory mechanism and a multi-layer privilege model, an interrupt of a corresponding execution environment may be directly processed based on an execution domain that is divided into, in other words, interrupts belonging to a same execution environment are executed by a same execution domain. An execution domain corresponding to each execution environment may be further refined and divided into a plurality of smaller execution domains, and interrupts of different interrupt sources belonging to the execution environment may be processed in each smaller execution domain. To facilitate subsequent application, the processor 602 further stores the correspondence between the execution environment identifier and the execution domain identifier in the register.

For different division mechanisms of execution domains corresponding to different execution environments, when the first execution environment identifier is the same as the second execution environment identifier, methods in which the processor executes the first interrupt instruction in the corresponding execution domain of the current execution environment are different. If the interrupts belonging to the same execution environment are executed by the same execution domain, the processor 602 may directly execute the first interrupt instruction in the current execution domain. If the interrupts belonging to the same execution environment are executed by different execution domains, the processor 602 may obtain an execution domain identifier corresponding to the target interrupt source identifier based on the stored correspondence between the interrupt source identifier and the execution domain identifier, and then execute the first interrupt instruction by running an execution domain corresponding to the execution domain identifier.

Further, when the first execution environment identifier is different from the second execution environment identifier, the processor 602 switches to the machine mode, sends the first interrupt instruction to trusted firmware run in the machine mode by running the current execution domain, and then forwards the first interrupt instruction by using the trusted firmware.

A processing process of the foregoing system on chip on the interrupt instruction is described below with reference to FIG. 5A. Assuming that the platform-level interrupt controller sets an interrupt source corresponding to the REE 521 and an interrupt source corresponding to the TEE 522 to an S mode (e.g., 525 or 524), execution domains corresponding to the REE is domain0 and domain1, and execution domains corresponding to the TEE is domain2 and domain3. Referring to FIG. 5A, in this case, an interrupt instruction \textcircled{1} is an interrupt instruction sent by an interrupt source corresponding to the REE 521, and an execution domain to which the interrupt source belongs is domain1. An interrupt instruction \textcircled{2} is an interrupt instruction sent by an interrupt source corresponding to the TEE 522, and an execution domain to which the interrupt source belongs is domain3. An interrupt instruction \textcircled{3} is an interrupt instruction sent by an interrupt source corresponding to the REE 521, and an execution domain to which the interrupt source belongs is domain0. An interrupt instruction \textcircled{4} is an interrupt instruction sent by an interrupt source corresponding to the TEE 522, and an execution domain to which the interrupt source belongs is domain2.

A processing procedure in which the current execution environment is the REE 521 is as follows:

In step S11, the processor 520 currently runs in the execution domain0.

In step S12, the PLIC 510 receives the interrupt instruction \textcircled{1}, where the interrupt instruction \textcircled{1} carries an interrupt source identifier; and sends the interrupt instruction \textcircled{1} to the processor 520.

In step S13, the processor 520 executes an interrupt processing program corresponding to the interrupt instruction \textcircled{1} in the execution domain1.

Specifically, after receiving the interrupt instruction \textcircled{1}, the processor 520 obtains an execution environment identifier corresponding to the interrupt instruction \textcircled{1} from the PLIC 510, and obtains an execution environment identifier of an execution environment to which the execution domain0 belongs. Because the execution environments are both the REE, the processor 520 determines that the belonged-to execution domain is the domain1 based on the interrupt source identifier carried in the interrupt instruction \textcircled{1}, and then directly executes the interrupt processing program corresponding to the interrupt instruction \textcircled{1} in the execution domain domain1.

When the processor 520 runs in the execution domain0, if the interrupt instruction \textcircled{4} is received, because an execution environment to which the interrupt instruction \textcircled{4} belongs is the TEE and is different from the current execution environment, i.e., the REE, the processor needs to switch to an M mode 523, sends the interrupt instruction \textcircled{4} to the domain2 by using the trusted firmware in the M mode 523, and then switches to the S mode 524, to execute the interrupt instruction \textcircled{4} in the domain2.

A processing procedure in which the current execution environment is the TEE 512 is as follows:

In step S21, the processor 520 currently runs in the execution domain2.

In step S22, the PLIC 510 receives the interrupt instruction \textcircled{2}, where the interrupt instruction \textcircled{2} carries an interrupt source identifier, and sends the interrupt instruction \textcircled{2} to the processor 520.

In step S23, the processor 520 executes an interrupt processing program corresponding to the interrupt instruction \textcircled{2} in the execution domain3.

Specifically, after receiving the interrupt instruction \textcircled{2}, the processor 520 obtains an execution environment identifier corresponding to the interrupt instruction \textcircled{2} from the PLIC 510, and obtains an execution environment identifier of an execution environment to which the execution domain0 belongs. Because the execution environments are both the TEE, the processor 520 determines that the belonged-to execution domain is the domain3 based on the interrupt source identifier carried in the interrupt instruction \textcircled{2}, and then directly executes the interrupt processing program corresponding to the interrupt instruction \textcircled{2} in the execution domain domain3.

When the processor 520 runs in the execution domain1, if the interrupt instruction \textcircled{3} is received, because an execution environment to which the interrupt instruction \textcircled{3} belongs is the REE and is different from the current execution environment, i.e., the TEE, the processor needs to switch to an M mode 523, sends the interrupt instruction \textcircled{3} to the domain0 by using the trusted firmware in the M mode 523, and then switches to the S mode 525, to execute the interrupt instruction \textcircled{3} in the domain0.

In a second case, the interrupt instruction is forwarded after processing by the interrupt controller.

After receiving a first interrupt instruction, the interrupt controller 601 obtains a first execution environment identifier corresponding to the first interrupt instruction, adds the first execution environment identifier to the first interrupt instruction, to obtain a second interrupt instruction, and then sends the second interrupt instruction to the processor. When receiving the second interrupt instruction, the processor 602 parses the second interrupt instruction to obtain the first execution environment identifier, and further obtains the second execution environment identifier corresponding to the current execution environment; and then compares the first execution environment identifier with the second execution environment identifier. When the first execution environment identifier is the same as the second execution environment identifier, the processor 602 executes the second interrupt instruction in a corresponding execution domain of the current execution environment.

The first interrupt instruction carries a target interrupt source identifier. To better manage interrupts of different interrupt sources, a register of the interrupt controller 601 stores a correspondence between an interrupt source identifier and an execution environment identifier. A process in which the interrupt controller generates the second interrupt instruction based on the first interrupt instruction is as follows: The interrupt controller 601 obtains, based on the target interrupt source identifier, the first execution environment identifier corresponding to the target interrupt source identifier from the correspondence between the interrupt source identifier and the execution environment identifier, and then adds the first execution environment identifier to the first interrupt instruction, to obtain the second interrupt instruction.

By using this processing method, a quantity of times that the processor accesses the interrupt controller is reduced, and security of data stored in the interrupt controller is improved.

Further, when the first execution environment identifier is different from the second execution environment identifier, the processor switches to the machine mode, sends the second interrupt instruction to the trusted firmware run in the machine mode by running the current execution domain, and forwards the first interrupt instruction by using the trusted firmware.

A processing process of the foregoing system on chip on the interrupt instruction is described below with reference to FIG. 5B. Assuming that the platform-level interrupt controller (PLIC) 510 sets an interrupt source corresponding to the REE 521 and an interrupt source corresponding to the TEE 522 to an S mode (e.g., 525 or 524), execution domains corresponding to the REE is domain0 and domain1, and execution domains corresponding to the TEE is domain2 and domain3. Referring to FIG. 5B, in this case, an interrupt instruction \textcircled{1} is an interrupt instruction sent by an interrupt source corresponding to the REE 521, and an execution domain to which the interrupt source belongs is domain1. An interrupt instruction \textcircled{2} is an interrupt instruction sent by an interrupt source corresponding to the TEE 522, and an execution domain to which the interrupt source belongs is domain3. An interrupt instruction \textcircled{3} is an interrupt instruction sent by an interrupt source corresponding to the REE 521, and an execution domain to which the interrupt source belongs is domain0. An interrupt instruction \textcircled{4} is an interrupt instruction sent by an interrupt source corresponding to the TEE 522, and an execution domain to which the interrupt source belongs is domain2.

A processing procedure in which the current execution environment is the REE 521 is as follows:

In step S31, the processor 520 currently runs in the execution domain0.

In step S32, the PLIC 510 receives the interrupt instruction \textcircled{1}. The interrupt instruction \textcircled{1} carries an interrupt source identifier. The PLIC 510 obtains an execution environment identifier corresponding to the interrupt source identifier based on the interrupt source identifier, adds the execution environment identifier to the interrupt instruction \textcircled{1} to obtain an interrupt instruction \textcircled{5}, and sends the interrupt instruction \textcircled{5} to the processor 520.

In step S33, the processor 520 executes an interrupt processing program corresponding to the interrupt instruction \textcircled{5} in the execution domain1.

Specifically, after receiving the interrupt instruction \textcircled{5}, the processor 520 parses the interrupt instruction \textcircled{5} to obtain a corresponding execution environment identifier, and obtains an execution environment identifier of an execution environment to which the execution domain0 belongs. Because the execution environments are both the REE 521, the processor 520 determines that belonged—to execution domain is the domain1 based on the interrupt source identifier carried in the interrupt instruction \textcircled{5}, and then directly executes the interrupt processing program corresponding to the interrupt instruction \textcircled{5} in the execution domain domain1.

When the processor 520 runs in the execution domain0, if the interrupt instruction \textcircled{6}, which carries an execution environment identifier as the same as the interrupt instruction \textcircled{4}, is received, because an execution environment to which the interrupt instruction \textcircled{6} belongs is the TEE 522 and is different from the current execution environment, i.e., the REE, the processor 520 needs to switch to an M mode 523, sends the interrupt instruction \textcircled{6} to the domain2 by using the trusted firmware in the M mode 523, and then switches to the S mode 524, to execute the interrupt instruction \textcircled{6} in the domain2.

A processing procedure in which the current execution environment is the TEE 522 is as follows:

In step S41, the processor 520 currently runs in the execution domain2.

In step S42, the PLIC 510 receives the interrupt instruction \textcircled{2}. The interrupt instruction \textcircled{2} carries an interrupt source identifier. The PLIC 510 obtains an execution environment identifier corresponding to the interrupt source identifier based on the interrupt source identifier, adds the execution environment identifier to the interrupt instruction \textcircled{2} to obtain an interrupt instruction \textcircled{7}, and sends the interrupt instruction \textcircled{7} to the processor 520.

In step S43, the processor 520 executes an interrupt processing program corresponding to the interrupt instruction \textcircled{7} in the execution domain3.

Specifically, after receiving the interrupt instruction \textcircled{7}, the processor 520 parses the interrupt instruction \textcircled{7} to obtain a corresponding execution environment identifier, and obtains an execution environment identifier of an execution environment to which the execution domain2 belongs. Because the execution environments are both the TEE, the processor 520 determines that the belonged—to execution domain is the domain3 based on the interrupt source identifier carried in the interrupt instruction \textcircled{7}, and then directly executes the interrupt processing program corresponding to the interrupt instruction \textcircled{7} in the execution domain3.

When the processor 520 runs in the execution domain1, if the interrupt instruction \textcircled{8}, which carries an execution environment identifier as the same as the interrupt instruction \textcircled{3}, is received, because an execution environment to which the interrupt instruction \textcircled{8} belongs is the REE and is different from the current execution environment, i.e., the TEE, the processor 520 needs to switch to an M mode 523, sends the interrupt instruction \textcircled{8} to the domain0 by using the trusted firmware in the M mode 523, and then switches to the S mode 525, to execute the interrupt instruction \textcircled{8} in the domain0.

It can be seen from the foregoing two examples that, in some embodiments of the present disclosure, by extending the execution environment identifier, after a TEE interrupt occurs on the TEE side, from a domain of the TEE, interrupt information may be directly queried to perform a response, the trusted firmware does not need to respond to the interrupt, and then the interrupt is forwarded to a corresponding execution domain of the TEE. After a REE interrupt occurs on the REE side, from a domain of the REE interrupt information may be directly queried to perform a response, the trusted firmware does not need to respond to the interrupt, and then the interrupt is forwarded to a corresponding execution domain of the REE. In short, for interrupts in a same execution environment, interrupt information of the interrupts may be obtained without switching to the M mode, to directly process the interrupts For interrupts in different execution environments, there is a need to switch to the M mode, and the interrupts are forwarded to a corresponding execution domain for execution by using the trusted firmware. By using the processing method, interrupt response efficiency is improved.

In addition, by extending the execution environment identifier, the processor may access the PLIC without being in the M mode, thereby improving an access speed to the PLIC, and shortening the interrupt response delay.

Only an interrupt on the REE side and an interrupt on the TEE side are used as examples for description above. The method is also applicable for another execution environment, which will not be described herein one by one.

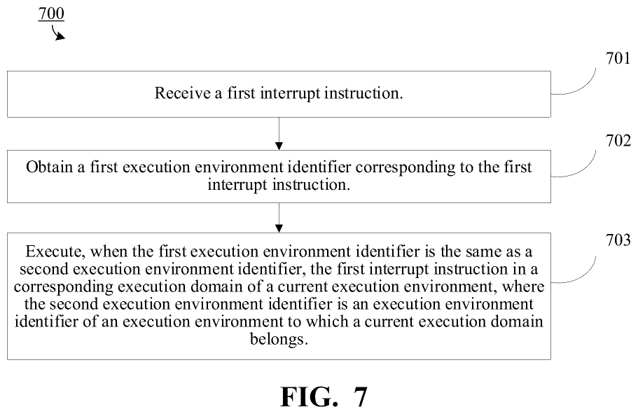

Some embodiments of the present disclosure provide an interrupt isolation method. An example in which a RISC-V architecture-based processor implemented is used. FIG. 7 is a flowchart of an exemplary interrupt isolation method 700, according to some embodiments of the present disclosure. Referring to FIG. 7, a procedure of the method 700 includes the steps 701 to 703.

In step 701, a first interrupt instruction is received.

The first interrupt instruction carries a target interrupt source identifier.

In step 702, a first execution environment identifier corresponding to the first interrupt instruction is obtained.

In response to the first interrupt instruction, the processor obtains the first execution environment identifier corresponding to the target interrupt source identifier by accessing an interrupt controller. Specifically, the processor sends an access request to the interrupt controller, where the access request carries the target interrupt source identifier. When receiving the access request, the interrupt controller obtains, based on the target interrupt source identifier, the first execution environment identifier corresponding to the target interrupt source identifier from a correspondence between an interrupt source identifier and an execution environment, and then sends the first execution environment identifier to the processor.

In step 703, when the first execution environment identifier is the same as a second execution environment identifier, the first interrupt instruction in a corresponding execution domain of a current execution environment is executed. The second execution environment identifier is an execution environment identifier of an execution environment to which a current execution domain belongs.

Further, when the first execution environment identifier is different from the second execution environment identifier, the processor sends the first interrupt instruction to trusted firmware run in a machine mode by running the current execution domain, and forwards the first interrupt instruction by using the trusted firmware.

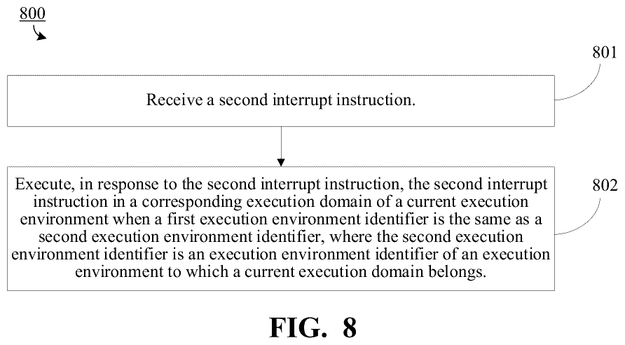

Some embodiments of the present disclosure provide another interrupt isolation method. FIG. 8 is a flowchart of another exemplary interrupt isolation method 800, according to some embodiments of the present disclosure. Referring to FIG. 8, a procedure of the method 800 includes steps 801 and 802.

In step 801, a second interrupt instruction is received.

The second interrupt instruction includes a first execution environment identifier, and the first execution environment identifier is an execution environment identifier of an execution environment to which a first interrupt instruction sent by an interrupt controller belongs.

In step 802, in response to the second interrupt instruction, the second interrupt instruction in a corresponding execution domain of a current execution environment is executed, when the first execution environment identifier is the same as a second execution environment identifier. The second execution environment identifier is an execution environment identifier of an execution environment to which a current execution domain belongs.

Further, when the first execution environment identifier is different from the second execution environment identifier, a processor sends the second interrupt instruction to trusted firmware run in a machine mode by running the current execution domain, and forwards the first interrupt instruction by using the trusted firmware.

By using the system on chip provided in some embodiments of the present disclosure, when an execution environment to which n interrupt source belongs is the same as an execution environment of a current execution domain, there is no need to forward by using the trusted firmware to respond to an interrupt instruction of the interrupt source, thereby improving a response speed, and shortening a response delay. The system on chip may form a computer device used in various scenes, for example, an IoT device used in the field of the Internet of Things and an intelligent device used in daily life. In the scenes, signal control becomes more sensitive through a timely interrupt response, thereby improving user experience.

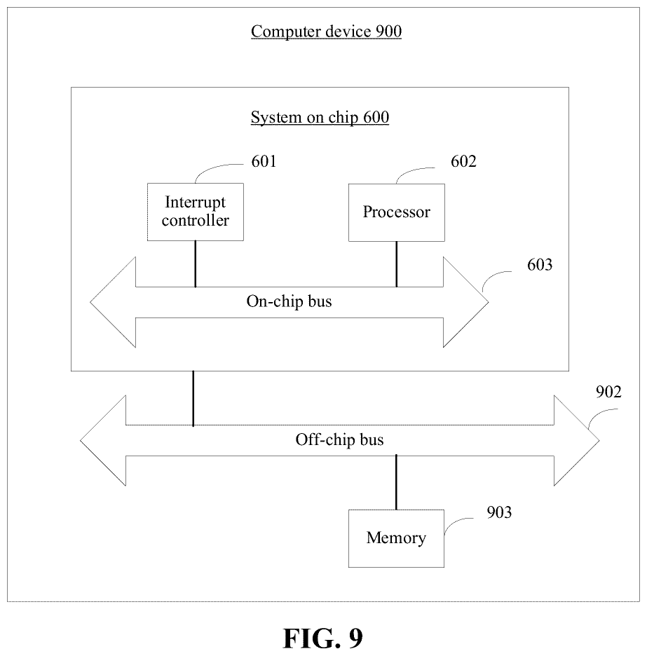

FIG. 9 is a schematic diagram of a structure of an exemplary computer device 900, according to some embodiments of the present disclosure. Generally, the computer device 900 includes the system on chip 600 as described in the foregoing embodiments in consistent with FIG. 6, an off-chip bus 902, and a memory 903. The system on chip 600 is connected to the memory 903 through the off-chip bus 902. The system on chip 600 includes the interrupt controller 601, the processor 602, and the on-chip bus 603.

The processor 602 may be implemented by using at least one hardware form of digital signal processing (DSP), a field-programmable gate array (FPGA), and a programmable logic array (PLA). The processor 602 may further include a main processor and a coprocessor. The main processor is a processor configured to process data in a wake-up state; and the coprocessor is a low-power-consumption processor configured to process data in a standby state. In some embodiments, the processor 602 may be integrated with a graphics processing unit (GPU), and the GPU is configured to render and draw content that needs to be displayed by a display screen. In some embodiments, the processor 602 may further include an artificial intelligence processor, and the artificial intelligence processor is configured to process a calculation operation related to machine learning.

The memory 903 may include one or more computer-readable storage media, and the computer-readable storage medium may be a non-transitory computer-readable storage medium, for example, the non-transitory computer-readable storage medium may be a compact disk read-only memory (CD-ROM), a ROM, a random access memory (RAM), a magnetic tape, a floppy disk, or an optical data storage device. The computer-readable storage medium stores at least one computer program, and the at least one computer program, when executed, can implement the interrupt isolation method.

In some embodiments, the foregoing computer device may further include another component, for example, an input/output interface or a communication component. The input/output interface provides an interface between the processor and a peripheral interface module, and the peripheral interface module may be an output device, an input device, or the like. The communication component is configured to facilitate wired or wireless communication between the computer device and another device.

A person skilled in the art may understand that, the structure shown in FIG. 9 does not constitute a limitation on the computer device 900, and may include more or fewer components than these shown in the figure, or combine some components, or use different component arrangements.

Some embodiments of the present disclosure provide a computer-readable storage medium, the computer readable storage medium stores at least one computer program, and the at least one computer program is loaded and executed by a processor of the foregoing system on chip, to implement the interrupt isolation method. The instructions may be executed by a device, for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

Some embodiments of the present disclosure provide a computer program product, the computer program product includes a computer program, and the computer program is loaded and executed by a processor of the foregoing system on chip, to implement the interrupt isolation method.

It may be clearly understood by a person skilled in the art that, for ease of description and conciseness, for a detailed working process of the foregoing system, apparatus, and unit, refer to a corresponding process in the foregoing method embodiments, and details are not described herein again.

The embodiments may further be described using the following clauses:
1. A system on chip, comprising an interrupt controller, a processor, and an on-chip bus, wherein the interrupt controller is connected to the processor through the on-chip bus;
the interrupt controller is configured to:
   store execution environment identifiers corresponding to different execution environments; and
   send, after receiving a first interrupt instruction, the first interrupt instruction to the processor; and
the processor is configured to:
   obtain, in response to the first interrupt instruction, a first execution environment identifier corresponding to the first interrupt instruction from the interrupt controller; and
   execute, when the first execution environment identifier is the same as a second execution environment identifier, the first interrupt instruction in a corresponding execution domain of a current execution environment, wherein the second execution environment identifier is an execution environment identifier of an execution environment to which a current execution domain belongs.
2. The system according to clause 1, wherein the interrupt controller comprises a register configured to store a correspondence between an interrupt source identifier and an execution environment identifier, and the first interrupt instruction carries a target interrupt source identifier;
the processor is further configured to:
   send, in response to the first interrupt instruction, an access request to the interrupt controller, the access request carrying the target interrupt source identifier; and
the interrupt controller is further configured to:
   obtain, in response to the access request, the first execution environment identifier corresponding to the target interrupt source identifier based on the stored correspondence between the interrupt source identifier and the execution environment identifier; and
   send the first execution environment identifier to the processor.
3. The system according to clause 2, wherein the access request carries the second execution environment identifier; and
the interrupt controller is further configured to:
   determine whether the second execution environment identifier is a stored execution environment identifier; and
   execute, when the second execution environment identifier is a stored execution environment identifier, the operation of obtaining the first execution environment identifier corresponding to the target interrupt source identifier.
4. The system according to clause 3, wherein the interrupt controller is further configured to reject access of the processor when the second execution environment identifier is not a stored execution environment identifier.
5. The system according to clause 1, wherein the processor is further configured to:
   send, when the first execution environment identifier is different from the second execution environment identifier, the first interrupt instruction to trusted firmware run in a machine mode by running the current execution domain; and
   forward the first interrupt instruction by using the trusted firmware.
6. The system according to any one of clauses 1 to 5, wherein the current execution environment comprises at least a trusted execution environment and a rich execution environment, each execution environment comprises at least one execution domain, and each execution domain comprises a corresponding operating system and application program.
7. The system according to claim 6, wherein the interrupt controller is further configured to:
set an interrupt source corresponding to the rich execution environment to a supervisor mode; and
set an interrupt source corresponding to the trusted execution environment to the supervisor mode or a machine mode.
8. An interrupt isolation method, wherein the method is applied to the system on chip according to any one of clauses 1 to 7, and the method comprises:
receiving a first interrupt instruction;
obtaining a first execution environment identifier corresponding to the first interrupt instruction; and
executing, when the first execution environment identifier is the same as a second execution environment identifier, the first interrupt instruction in a corresponding execution domain of a current execution environment, wherein the second execution environment identifier is an execution environment identifier of an execution environment to which a current execution domain belongs.
9. The method according to clause 8, wherein the first interrupt instruction carries a target interrupt source identifier, and the obtaining a first execution environment identifier corresponding to the first interrupt instruction further comprises:
obtaining, based on the target interrupt identifier, the first execution environment identifier corresponding to the target interrupt source identifier by accessing an interrupt controller.
10. The method according to clause 8, wherein the method further comprises:
sending, when the first execution environment identifier is different from the second execution environment identifier, the first interrupt instruction to trusted firmware run in a machine mode by running the current execution domain; and
forwarding the first interrupt instruction by using the trusted firmware.
11. A system on chip, comprising an interrupt controller, a processor, and an on-chip bus, and the interrupt controller is connected to the processor through the on-chip bus;
the interrupt controller is configured to:
   store execution environment identifiers corresponding to different execution environments, and obtain, after receiving a first interrupt instruction, a first execution environment identifier corresponding to the first interrupt instruction; and
   add the first execution environment identifier to the first interrupt instruction, to obtain a second interrupt instruction, and send the second interrupt instruction to the processor; and
the processor is configured to:
   execute, in response to the second interrupt instruction, the first interrupt instruction in a corresponding execution domain of a current execution environment when the first execution environment identifier is the same as a second execution environment identifier, wherein the second execution environment identifier is an execution environment identifier of an execution environment to which a current execution domain belongs.
12. The system according to clause 11, wherein the processor is further configured to:
   send, when the first execution environment identifier is different from the second execution environment identifier, the second interrupt instruction to trusted firmware run in a machine mode by running the current execution domain; and forward the first interrupt instruction by using the trusted firmware.
13. An interrupt isolation method, wherein the method is applied to the system on chip according to clause 11 or 12, and the method comprises:
receiving a second interrupt instruction, wherein the second interrupt instruction comprises a first execution environment identifier, and the first execution environment identifier is an execution environment identifier of an execution environment to which a first interrupt instruction sent by an interrupt controller belongs; and
executing, in response to the second interrupt instruction, the second interrupt instruction in a corresponding execution domain of a current execution environment when the first execution environment identifier is the same as a second execution environment identifier, wherein the second execution environment identifier is an execution environment identifier of an execution environment to which a current execution domain belongs.
14. A computer device, comprising a system on chip, an off-chip bus, and a memory, wherein the system on chip is connected to the memory through the off-chip bus;
the system on chip is the system on chip according to any one of clauses 1 to 7, or the system on chip according to clause 11 or 12; and
the memory is configured to store at least one computer program, and the at least one computer program is loaded and executed by a processor of the system on chip, to implement the interrupt isolation method according to any one of clauses 8 to 10, or implement the interrupt isolation method according to clause 11 or 12.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A system on chip, comprising an interrupt controller, a processor, and an on-chip bus, wherein the interrupt controller is connected to the processor through the on-chip bus;
the interrupt controller is configured to:
store execution environment identifiers corresponding to different execution environments; and
send, after receiving a first interrupt instruction, the first interrupt instruction to the processor; and
the processor is configured to:
obtain, in response to the first interrupt instruction, a first execution environment identifier corresponding to the first interrupt instruction from the interrupt controller; and
execute, when the first execution environment identifier is the same as a second execution environment identifier, the first interrupt instruction in a corresponding execution domain of a current execution environment, wherein the second execution environment identifier is an execution environment identifier of an execution environment to which a current execution domain belongs.

2. The system according to claim 1, wherein the interrupt controller comprises a register configured to store a correspondence between an interrupt source identifier and an execution environment identifier, and the first interrupt instruction carries a target interrupt source identifier;
the processor is further configured to:
send, in response to the first interrupt instruction, an access request to the interrupt controller, the access request carrying the target interrupt source identifier; and
the interrupt controller is further configured to:
obtain, in response to the access request, the first execution environment identifier corresponding to the target interrupt source identifier based on the stored correspondence between the interrupt source identifier and the execution environment identifier; and
send the first execution environment identifier to the processor.

3. The system according to claim 2, wherein the access request carries the second execution environment identifier, and the interrupt controller is further configured to:
determine whether the second execution environment identifier is a stored execution environment identifier; and
obtaining, when the second execution environment identifier is a stored execution environment identifier, the first execution environment identifier corresponding to the target interrupt source identifier.

4. The system according to claim 3, wherein the interrupt controller is further configured to reject access of the processor when the second execution environment identifier is not a stored execution environment identifier.

5. The system according to claim 1, wherein the interrupt controller is further configured to:
obtain, after receiving the first interrupt instruction, the first execution environment identifier corresponding to the first interrupt instruction;
add the first execution environment identifier to the first interrupt instruction; and
send the first interrupt instruction with the first interrupt instruction to the processor.

6. The system according to claim 1, wherein the interrupt controller is configured to:
send, when the first execution environment identifier is different from the second execution environment identifier, the first interrupt instruction to trusted firmware run in a machine mode by running the current execution domain; and
forward the first interrupt instruction by using the trusted firmware.

7. The system according to claim 1, wherein the current execution environment comprises at least a trusted execution environment and a rich execution environment, each execution environment comprises at least one execution domain comprising a corresponding operating system and application program.

8. The system according to claim 7, wherein the interrupt controller is further configured to:
set an interrupt source corresponding to the rich execution environment to a supervisor mode; and
set an interrupt source corresponding to the trusted execution environment to the supervisor mode or a machine mode.

9. An interrupt isolation method, applied on a processor, wherein the method comprises:
receiving a first interrupt instruction;
obtaining a first execution environment identifier corresponding to the first interrupt instruction; and
executing, when the first execution environment identifier is the same as a second execution environment identifier, the first interrupt instruction in a corresponding execution domain of a current execution environment, wherein the second execution environment identifier is an execution environment identifier of an execution environment to which a current execution domain belongs.

10. The method according to claim 9, wherein the first interrupt instruction carries a target interrupt source identifier, and obtaining the first execution environment identifier corresponding to the first interrupt instruction further comprises:
obtaining, based on the target interrupt identifier, the first execution environment identifier corresponding to the target interrupt source identifier by accessing an interrupt controller.

11. The method according to claim 9, further comprising:
sending, when the first execution environment identifier is different from the second execution environment identifier, the first interrupt instruction to trusted firmware run in a machine mode by running the current execution domain; and
forwarding the first interrupt instruction by using the trusted firmware.

12. An interrupt isolation method, applied on an interrupt controller, wherein the method comprises:
storing execution environment identifiers corresponding to different execution environments; and
sending, after receiving a first interrupt instruction, the first interrupt instruction to a processor.

13. The method according to claim 12, wherein the first interrupt instruction carries a target interrupt source identifier, and the method further comprises:
obtaining, in response to an access request, a first execution environment identifier corresponding to the target interrupt source identifier based on the stored correspondence between the interrupt source identifier and the execution environment identifier; and
sending the first execution environment identifier to the processor.

14. The method according to claim 13, wherein the access request carries a second execution environment identifier, the second execution environment identifier being an execution environment identifier of an execution environment to which a current execution domain belongs, and the method further comprising:
determining whether the second execution environment identifier is a stored execution environment identifier; and
obtaining, when the second execution environment identifier is a stored execution environment identifier, the first execution environment identifier corresponding to the target interrupt source identifier.

15. The method according to claim 14, further comprising:
rejecting access of the processor when the second execution environment identifier is not a stored execution environment identifier.

16. The method according to claim 12, wherein an execution environment of the different execution environments comprises at least a trusted execution environment and a rich execution environment, each execution environment comprises at least one execution domain comprising a corresponding operating system and application program, and the method further comprises:
setting an interrupt source corresponding to the rich execution environment to a supervisor mode; and
setting an interrupt source corresponding to the trusted execution environment to the supervisor mode or a machine mode.

17. The method according to claim 12, further comprising:
obtaining, after receiving the first interrupt instruction, a first execution environment identifier corresponding to the first interrupt instruction;
adding the first execution environment identifier to the first interrupt instruction; and
sending the first interrupt instruction with the first execution environment identifier to the processor.
